(19) United States
(12) Patent Application Publication
(10) Pub. No.: US 2024/0353253 A1
(43) Pub. Date: Oct. 24, 2024

(54) DETECTION SYSTEM, DETECTION APPARATUS, AND DETECTION METHOD

(71) Applicant: NEC Corporation, Minato-ku, Tokyo (JP)

(72) Inventor: Tadayuki Iwano, Tokyo (JP)

(73) Assignee: NEC Corporation, Minato-ku, Tokyo (JP)

(21) Appl. No.: 18/684,889

(22) PCT Filed: Sep. 1, 2021
(86) PCT No.: PCT/JP2021/032160

§ 371 Date: Feb. 20, 2024

(51) Int. Cl. G01H 9/00; G01D 5/353

(52) U.S. Cl. CPC G01H 9/004; G01D 5/35358

(57) ABSTRACT

A detection system (1) according to the present disclosure includes: a first optical fiber cable (10-1) and a second optical fiber cable (10-2), a sensing unit (20) configured to perform optical fiber sensing using each of the first optical fiber cable (10-1) and the second optical fiber cable (10-2) to acquire first sensing data corresponding to the first optical fiber cable (10-1) and acquire second sensing data corresponding to the second optical fiber cable (10-2), and an abnormality detection unit (30) configured to detect occurrence of abnormality in the first optical fiber cable (10-1) or the second optical fiber cable (10-2) on the basis of both the first optical fiber cable (10-1) and the second optical fiber cable (10-2).

### TECHNICAL FIELD

The present disclosure relates to a detection system, a detection apparatus, and a detection method.

### BACKGROUND ART

In recent years, a technology called optical fiber sensing that performs sensing using an optical fiber as a sensor has attracted attention.

Examples of optical fiber sensing include interference type optical fiber sensing. For example, Patent Literature 1 discloses a technology of detecting a physical quantity by performing interference type optical fiber sensing using interference light in which reflected light received from a sensing fiber and reflected light received from a reference fiber interfere with each other.

Further, another example of the optical fiber sensing is distributed fiber optic sensing (DFOS) such as distributed vibration sensing (DVS). For example, Patent Literature 2 discloses a technology of detecting an environment around an optical fiber cable (for example, a state of a structure such as a utility pole) by performing distributed optical fiber sensing.

### CITATION LIST

### Patent Literature

Patent Literature 1: Japanese Unexamined Patent Application Publication No. 2008-175746
Patent Literature 2: International Patent Publication No. WO2021/070222

### SUMMARY OF INVENTION

### Technical Problem

As described above, the technology disclosed in Patent Literature 2 detects the environment around the optical fiber cable by performing distributed optical fiber sensing. However, abnormality (for example, damage or the like due to animal feeding damage) may occur in the optical fiber cable itself. When abnormality occurs in the optical fiber cable itself, the detection result also changes.

However, the technology disclosed in Patent Literature 2 has a problem in that it is difficult to determine whether the change in the detection result is caused by the change in the environment around the optical fiber cable or the abnormality generated in the optical fiber cable itself.

Therefore, an object of the present disclosure is to solve the above-described problems and to provide a detection system, a detection apparatus, and a detection method capable of detecting that abnormality has occurred in an optical fiber cable itself.

### Solution to Problem

A detection system according to one aspect includes:

a first optical fiber cable and a second optical fiber cable;

a sensing unit configured to acquire first sensing data corresponding to the first optical fiber cable and second sensing data corresponding to the second optical fiber cable by performing optical fiber sensing using each of the first optical fiber cable and the second optical fiber cable; and

an abnormality detection unit configured to detect occurrence of abnormality in the first optical fiber cable or the second optical fiber cable on the basis of both the first sensing data and the second sensing data.

A detection apparatus according to one aspect includes:

an acquisition unit configured to acquire first sensing data corresponding to a first optical fiber cable and second sensing data corresponding to a second optical fiber cable from a sensing unit configured to perform optical fiber sensing using each of the first optical fiber cable and the second optical fiber cable; and

an abnormality detection unit configured to detect occurrence of abnormality in the first optical fiber cable or the second optical fiber cable on the basis of both the first sensing data and the second sensing data.

A detection method according to one aspect is a detection method by a detection apparatus, including:

an acquisition step of acquiring first sensing data corresponding to a first optical fiber cable and second sensing data corresponding to a second optical fiber cable from a sensing unit configured to perform optical fiber sensing using each of the first optical fiber cable and the second optical fiber cable; and

an abnormality detection step of detecting occurrence of abnormality in the first optical fiber cable or the second optical fiber cable on the basis of both the first sensing data and the second sensing data.

### Advantageous Effects of Invention

According to the above-described aspects, it is possible to provide the detection system, the detection apparatus, and the detection method capable of detecting that abnormality has occurred in the optical fiber cable itself.

### BRIEF DESCRIPTION OF DRAWINGS

FIG. 1 is a diagram illustrating a configuration example of a detection system according to a first example embodiment.

FIG. 2 is a diagram illustrating a modified configuration example of the detection system according to the first example embodiment.

FIG. 3 is a flowchart illustrating an example of a schematic operation flow in a case where occurrence of abnormality in a first optical fiber cable or a second optical fiber cable is detected in the detection system according to the first example embodiment.

FIG. 4 is a diagram illustrating a configuration example of a detection system according to a second example embodiment.

FIG. 5 is a diagram illustrating an example in which a difference value between vibration intensity indicated by first sensing data and vibration intensity indicated by second sensing data changes when abnormality occurs in either a first optical fiber cable or a second optical fiber cable.

FIG. 6 is a flowchart illustrating an example of a schematic operation flow in a case where occurrence of abnormality in the first optical fiber cable or the second optical fiber cable is detected in the detection system according to the second example embodiment.

FIG. 7 is a diagram illustrating an example of a correspondence table used by an abnormality detection unit according to another example embodiment.

FIG. 8 is a block diagram illustrating a hardware configuration example of a computer that realizes a detection apparatus according to each example embodiment.

### EXAMPLE EMBODIMENT

Example embodiments of the present disclosure are described below with reference to the drawings. Furthermore, in the description and drawings to be described below, omission and simplification are made as appropriate, for clarity of description. Furthermore, in the following drawings, the same elements will be denoted by the same reference signs, and redundant description will be omitted as necessary.

### First Example Embodiment

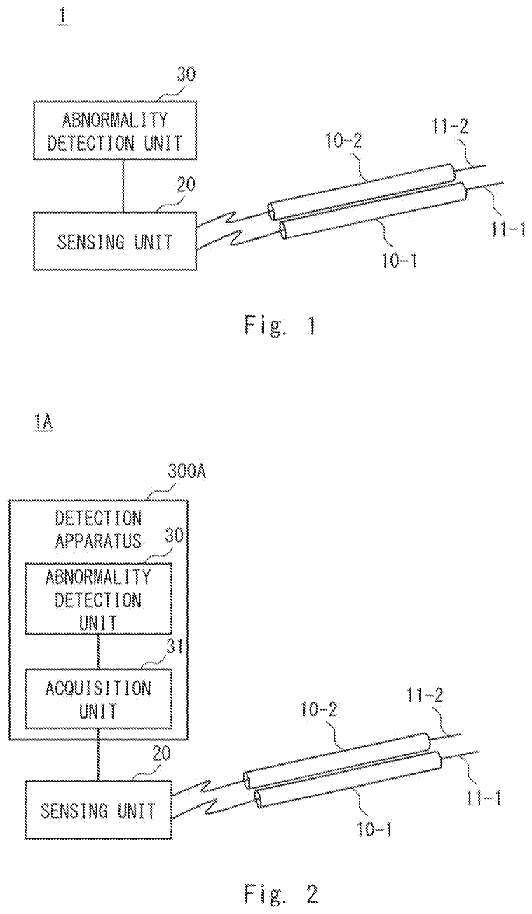

First, a configuration example of a detection system 1 according to a first example embodiment will be described with reference to FIG. 1.

As illustrated in FIG. 1, the detection system 1 according to the first example embodiment includes a first optical fiber cable 10-1, a second optical fiber cable 10-2, a sensing unit 20, and an abnormality detection unit 30.

The first optical fiber cable 10-1 includes at least one first optical fiber 11-1. In addition, the second optical fiber cable 10-2 includes at least one second optical fiber 11-2.

The first optical fiber cable 10-1 and the second optical fiber cable 10-2 are arranged to extend substantially parallel to each other. In addition, the first optical fiber cable 10-1 and the second optical fiber cable 10-2 are arranged adjacent to each other. For example, the first optical fiber cable 10-1 and the second optical fiber cable 10-2 may be disposed in close contact with each other or may be disposed at a predetermined interval.

In FIG. 1, two optical fiber cables including the first optical fiber cable 10-1 and the second optical fiber cable 10-2 are provided, but the number of optical fiber cables is not limited to two and may be three or more.

The sensing unit 20 performs optical fiber sensing using each of the first optical fiber cable 10-1 and the second optical fiber cable 10-2. For example, the sensing unit 20 performs distributed optical fiber sensing. As a result, the sensing unit 20 acquires first sensing data indicating the detection result (for example, vibration generated around the first optical fiber cable 10-1) detected by the first optical fiber cable 10-1 and acquires second sensing data indicating the detection result (for example, vibration generated around the second optical fiber cable 10-2) detected by the second optical fiber cable 10-2.

The abnormality detection unit 30 detects the occurrence of abnormality in the first optical fiber cable 10-1 or the second optical fiber cable 10-2 on the basis of both the first sensing data and the second sensing data acquired by the sensing unit 20.

Furthermore, the abnormality detection unit 30 may be provided in the same apparatus as the sensing unit 20, may be provided in an apparatus different from the sensing unit 20, or may be provided on a cloud. FIG. 2 illustrates a configuration example of a detection system 1A in which the abnormality detection unit 30 is provided in an apparatus (detection apparatus 300A) different from the sensing unit 20. In the detection system 1A illustrated in FIG. 2, an acquisition unit 31 that acquires the first sensing data and the second sensing data from the sensing unit 20 is added to the detection apparatus 300A.

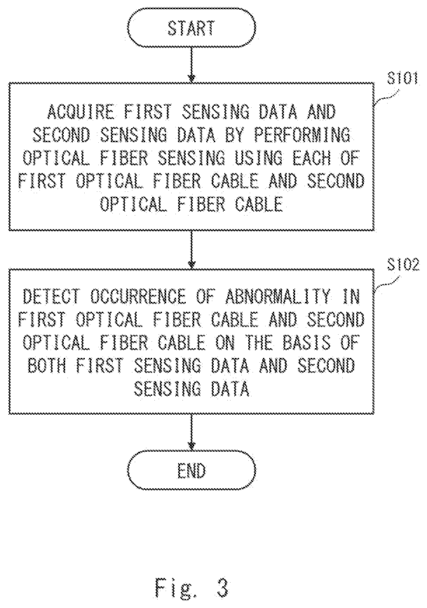

Next, an example of a schematic operation flow in a case where the occurrence of abnormality in the first optical fiber cable 10-1 or the second optical fiber cable 10-2 is detected in the detection system 1 according to the first example embodiment will be described with reference to FIG. 3.

As illustrated in FIG. 3, first, the sensing unit 20 performs optical fiber sensing using each of the first optical fiber cable 10-1 and the second optical fiber cable 10-2. As a result, the sensing unit 20 acquires the first sensing data corresponding to the first optical fiber cable 10-1 and acquires the second sensing data corresponding to the second optical fiber cable 10-2 (step S101).

Thereafter, the abnormality detection unit 30 detects the occurrence of abnormality in the first optical fiber cable 10-1 or the second optical fiber cable 10-2 on the basis of both the first sensing data and the second sensing data acquired by the sensing unit 20 (step S102).

As described above, according to the first example embodiment, the sensing unit 20 performs the optical fiber sensing using each of the first optical fiber cable 10-1 and the second optical fiber cable 10-2 to acquire the first sensing data corresponding to the first optical fiber cable 10-1 and acquire the second sensing data corresponding to the second optical fiber cable 10-2. The abnormality detection unit 30 detects the occurrence of abnormality in the first optical fiber cable 10-1 or the second optical fiber cable 10-2 on the basis of both the first sensing data and the second sensing data. As a result, it is possible to detect that an abnormality has occurred in the first optical fiber cable 10-1 or the second optical fiber cable 10-2 itself.

### Second Example Embodiment

A second example embodiment is a specific example embodiment of the first example embodiment described above, and is an example of detecting a traveling state of a vehicle around an optical fiber cable as an environment around the optical fiber cable.

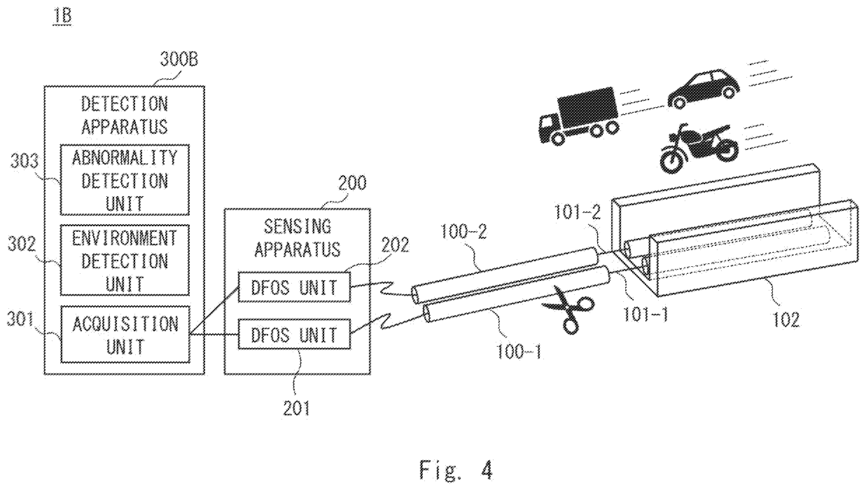

First, a configuration example of a detection system 1B according to the second example embodiment will be described with reference to FIG. 4.

As illustrated in FIG. 4, the detection system 1B according to the second example embodiment includes a first optical fiber cable 100-1, a second optical fiber cable 100-2, a sensing apparatus 200, and a detection apparatus 300B. FIG. 4 illustrates a state in which abnormality (here, human damage using an edged tool) occurs in the first optical fiber cable 100-1.

The first optical fiber cable 100-1 and the second optical fiber cable 100-2 correspond to the first optical fiber cable 10-1 and the second optical fiber cable 10-2 in the first example embodiment described above. Hereinafter, when the first optical fiber cable 100-1 or the second optical fiber cable 100-2 is not particularly specified, the cable is appropriately referred to as an “optical fiber cable 100”. Furthermore, the sensing apparatus 200 corresponds to the sensing unit 20 in the first example embodiment described above. An abnormality detection unit 303 and an acquisition unit 301 described later in the detection apparatus 300B correspond to the abnormality detection unit 30 and the acquisition unit 31 in the first example embodiment described above, respectively.

The first optical fiber cable 100-1 includes at least one first optical fiber 101-1. In addition, the second optical fiber cable 100-2 includes at least one second optical fiber 101-2.

The first optical fiber cable 100-1 and the second optical fiber cable 100-2 are arranged substantially parallel to each other and extend along a road (not illustrated). In FIG. 4, the first optical fiber cable 100-1 and the second optical fiber cable 100-2 are arranged inside a truss 103 installed along the road, but the present disclosure is not limited to this arrangement method, and the first optical fiber cable and the second optical fiber cable may be arranged along the road.

In addition, the first optical fiber cable 100-1 and the second optical fiber cable 100-2 are arranged adjacent to each other. For example, the first optical fiber cable 100-1 and the second optical fiber cable 100-2 may be disposed in close contact with each other or may be disposed at a predetermined interval.

In FIG. 4, two optical fiber cables including the first optical fiber cable 100-1 and the second optical fiber cable 100-2 are provided, but the number of optical fiber cables 100 is not limited to two and may be three or more.

The sensing apparatus 200 performs distributed optical fiber sensing using each of the first optical fiber cable 100-1 and the second optical fiber cable 100-2, and includes a first DFOS unit 201 and a second DFOS unit 202. The first DFOS unit 201 and the second DFOS unit 202 are realized by, for example, DVS. Furthermore, in FIG. 4, the first DFOS unit 201 and the second DFOS unit 202 are provided in the same apparatus (sensing apparatus 200), but may be provided in different apparatuses.

In a case where the distributed optical fiber sensing is performed, the first DFOS unit 201 enters pulsed light into the first optical fiber 101-1 constituting the first optical fiber cable 100-1, and receives backscattered light generated as the pulsed light is transmitted through the first optical fiber 101-1 via the first optical fiber 101-1.

Here, when the vehicle travels around the first optical fiber cable 100-1, vibration is generated, and the vibration is transmitted to the first optical fiber cable 100-1. As a result, the characteristics (for example, the wavelength) of the backscattered light transmitted through the first optical fiber 101-1 constituting the first optical fiber cable 100-1 change. Therefore, the first optical fiber cable 100-1 can detect vibration generated by traveling of the vehicle around the first optical fiber cable 100-1.

In addition, since characteristics of the backscattered light transmitted through the first optical fiber 101-1 change according to vibration generated by traveling of the vehicle of the first optical fiber cable 100-1, the backscattered light includes first sensing data indicating vibration data of the vibration.

Therefore, the first DFOS unit 201 performs distributed optical fiber sensing to acquire first sensing data indicating vibration data of vibration generated by traveling of the vehicle around the first optical fiber cable 100-1.

Similarly, in a case where the distributed optical fiber sensing is performed, the second DFOS unit 202 enters pulsed light into the second optical fiber 101-2 constituting the second optical fiber cable 100-2, and receives backscattered light generated as the pulsed light is transmitted through the second optical fiber 101-2 via the second optical fiber 101-2. Then, the second DFOS unit 202 acquires second sensing data indicating vibration data of vibration generated by traveling of the vehicle around the second optical fiber cable 100-2.

The detection apparatus 300B includes the acquisition unit 301, an environment detection unit 302, and the abnormality detection unit 303.

The acquisition unit 301 acquires the first sensing data from the first DFOS unit 201 and acquires the second sensing data from the second DFOS unit 202.

Here, the first sensing data indicates vibration data of vibration generated by traveling of the vehicle around the first optical fiber cable 100-1, and the second sensing data indicates vibration data of vibration generated by traveling of the vehicle around the second optical fiber cable 100-2. The first optical fiber cable 100-1 and the second optical fiber cable 100-2 are disposed adjacent to each other.

Therefore, the environment detection unit 302 detects the traveling state of the vehicle around the first optical fiber cable 100-1 and the second optical fiber cable 100-2 on the basis of at least one of the first sensing data and the second sensing data.

When both the first optical fiber cable 100-1 and the second optical fiber cable 100-2 are normal, the difference value between the vibration intensity indicated by the first sensing data and the vibration intensity indicated by the second sensing data is a difference in vibration intensity according to the positional relationship between the first optical fiber cable 100-1 and the second optical fiber cable 100-2. Therefore, as long as the positional relationship between the first optical fiber cable 100-1 and the second optical fiber cable 100-2 does not change, the above-described difference value becomes a substantially constant value.

However, when abnormality (for example, damage or the like due to animal feeding damage) occurs in either the first optical fiber cable 100-1 or the second optical fiber cable 100-2, only sensing data corresponding to the optical fiber cable 100 in which the abnormality has occurred out among the first sensing data and the second sensing data changes (for example, the value of the vibration intensity indicated by the sensing data changes from a value when the optical fiber cable 100 is normal by exceeding a predetermined threshold. The same applies hereinafter.). As a result, the above-described difference value, which is a substantially constant value at the normal time, changes (for example, the difference value changes from a value when the optical fiber cable 100 is normal by exceeding a predetermined threshold. The same applies hereinafter.).

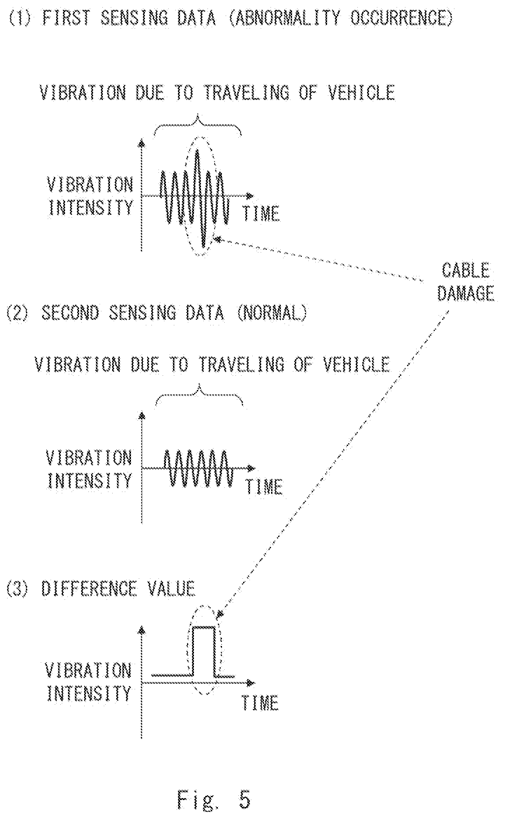

Here, the fact that the above-described difference value changes when abnormality occurs in either the first optical fiber cable 100-1 or the second optical fiber cable 100-2 will be described with reference to FIG. 5. FIG. 5 illustrates an example in which abnormality (damage) occurs in the first optical fiber cable 100-1. In FIG. 5, the first sensing data and the second sensing data indicate vibration data of vibration detected at positions on the first optical fiber cable 100-1 and the second optical fiber cable 100-2 at the same distance from the sensing apparatus 200, respectively, where the horizontal axis represents time and the vertical axis represents vibration intensity.

As illustrated in FIG. 5, only the vibration generated according to the traveling of the vehicle appears in the second sensing data corresponding to the normal second optical fiber cable 100-2.

On the other hand, in the second sensing data corresponding to the first optical fiber cable 100-1 in which the abnormality (damage) has occurred, vibration generated according to traveling of the vehicle appears, and vibration generated according to the abnormality (damage) also appears.

As a result, a peak occurs in a difference value between the vibration intensity indicated by the first sensing data and the vibration intensity indicated by the second sensing data. This peak does not occur when both the first optical fiber cable 100-1 and the second optical fiber cable 100-2 are normal.

Therefore, the abnormality detection unit 303 detects the occurrence of abnormality in the first optical fiber cable 100-1 or the second optical fiber cable 100-2 on the basis of the difference value between the vibration intensity indicated by the first sensing data and the vibration intensity indicated by the second sensing data.

Examples of the type of abnormality of the optical fiber cable 100 include damage of the optical fiber cable 100 due to animal feeding damage, damage of the optical fiber cable 100 caused by a human using a blade or the like, deterioration of the optical fiber cable 100, and external pressure (for example, external pressure due to displacement of a trough 102) on the optical fiber cable 100.

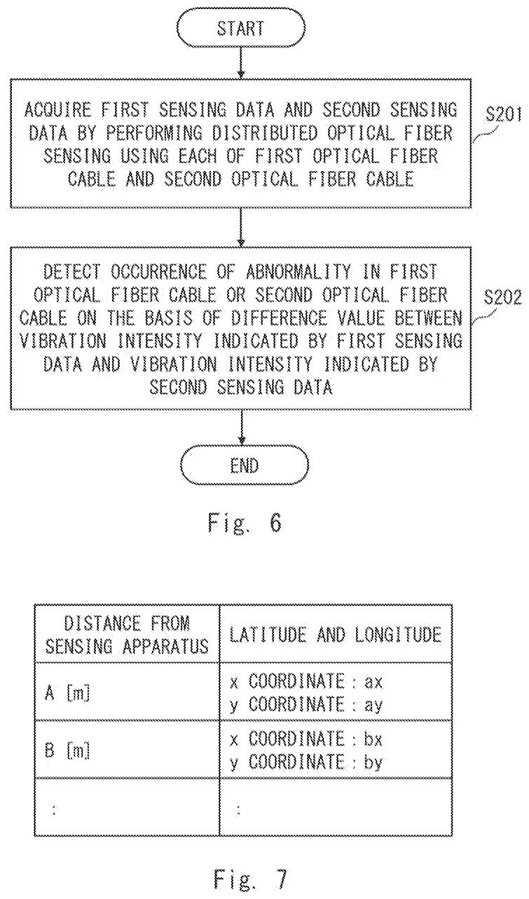

Next, an example of a schematic operation flow in a case where the occurrence of abnormality in the first optical fiber cable 100-1 or the second optical fiber cable 100-2 is detected in the detection system 1B according to the second example embodiment will be described with reference to FIG. 6.

As illustrated in FIG. 6, first, the sensing apparatus 200 performs distributed optical fiber sensing using each of the first optical fiber cable 100-1 and the second optical fiber cable 100-2. As a result, the sensing apparatus 200 acquires the first sensing data corresponding to the first optical fiber cable 100-1 and acquires the second sensing data corresponding to the second optical fiber cable 100-2 (step S201).

Thereafter, in the detection apparatus 300B, the acquisition unit 301 acquires the first sensing data and the second sensing data acquired by the sensing apparatus 200. Then, the abnormality detection unit 303 detects the occurrence of abnormality in the first optical fiber cable 100-1 or the second optical fiber cable 100-2 on the basis of the difference value between the vibration intensity indicated by the first sensing data and the vibration intensity indicated by the second sensing data (step S202).

As described above, according to the second example embodiment, the sensing apparatus 200 performs the distributed optical fiber sensing using each of the first optical fiber cable 100-1 and the second optical fiber cable 100-2 to acquire the first sensing data corresponding to the first optical fiber cable 100-1 and acquire the second sensing data corresponding to the second optical fiber cable 100-2. The detection apparatus 300B detects the occurrence of abnormality in the first optical fiber cable 100-1 or the second optical fiber cable 100-2 on the basis of a difference value between the vibration intensity indicated by the first sensing data and the vibration intensity indicated by the second sensing data. As a result, it is possible to detect that abnormality has occurred in the first optical fiber cable 100-1 or the second optical fiber cable 100-2 itself.

### Another Example Embodiment

The abnormality detection unit 303 according to the second example embodiment described above can add or modify the operation as follows.

The abnormality detection unit 303 does not need to always monitor the difference value between the vibration intensity indicated by the first sensing data and the vibration intensity indicated by the second sensing data, and may monitor the difference value described above in response to change in either the first sensing data or the second sensing data. According to this configuration, it is possible to reduce the processing load of the abnormality detection unit 303 as compared with the configuration in which the difference value is always monitored.

When detecting the occurrence of the abnormality in the first optical fiber cable 100-1 or the second optical fiber cable 100-2 on the basis of the difference value, the abnormality detection unit 303 may specify the optical fiber cable 100 corresponding to the sensing data in which the change occurs among the first sensing data and the second sensing data as the optical fiber cable 100 in which the abnormality has occurred.

In addition, in a case where the abnormality detection unit 303 detects the occurrence of the abnormality in the first optical fiber cable 100-1 or the second optical fiber cable 100-2 on the basis of the difference value described above and the change occurs in both the first sensing data and the second sensing data, the abnormality detection unit 303 may be determined that the abnormality occurs in both the first optical fiber cable 100-1 and the second optical fiber cable 100-2.

In addition, the abnormality detection unit 303 may notify the system user of the optical fiber cable 100 in which the abnormality has occurred. In this case, the abnormality detection unit 303 may transmit a graphical user interface (GUI) screen indicating the optical fiber cable 100 in which the abnormality has occurred to a terminal (not illustrated) of the system user.

In addition, for example, the abnormality detection unit 303 can specify the position where the first sensing data included in the backscattered light is detected (distance from the sensing apparatus 200) on the basis of the time difference between the time when the first DFOS unit 201 enters the pulsed light into the first optical fiber cable 100-1 and the time when the first DFOS unit 201 receives the backscattered light from the first optical fiber cable 100-1. By using this, when abnormality occurs in the first optical fiber cable 100-1, the abnormality detection unit 303 may specify the abnormality occurrence position (distance from the sensing apparatus 200) on the first optical fiber cable 100-1. Furthermore, as illustrated in FIG. 7, a correspondence table in which the distance from the sensing apparatus 200 and the latitude and longitude information at the distance are associated with each other may be stored in advance in a memory (not illustrated) or the like. In this case, the abnormality detection unit 303 may specify the latitude and longitude of the abnormality occurrence position on the first optical fiber cable 100-1 using the correspondence table illustrated in FIG. 7.

Similarly, the abnormality detection unit 303 may specify the abnormality occurrence position (distance from the sensing apparatus 200 or latitude and longitude) on the second optical fiber cable 100-2.

In addition, the abnormality detection unit 303 may notify the system user of the abnormality occurrence position (distance from sensing apparatus 200 or latitude and longitude) on the optical fiber cable 100. In this case, the abnormality detection unit 303 may transmit the GUI screen indicating the abnormality occurrence position on the optical fiber cable 100 to the terminal (not illustrated) of the system user.

In addition, as described above, examples of the type of abnormality of the optical fiber cable 100 include damage of the optical fiber cable 100 due to animal feeding damage, damage of the optical fiber cable 100 using a blade or the like, deterioration of the optical fiber cable 100, external pressure on the optical fiber cable 100, and the like. The pattern of the difference value described above is a unique variation pattern in which the intensity of the peak, the peak occurrence position, the number of peaks, and the like are different according to the type of abnormality.

Therefore, the abnormality detection unit 303 may specify the type of the abnormality generated in the optical fiber cable 100 using the fact that the pattern of the difference value described above is a unique variation pattern according to the type of the abnormality. As this specifying method, for example, the following is considered.

For each type of abnormality in the optical fiber cable 100, the abnormality detection unit 303 prepares multiple sets of training data indicating the abnormality and patterns of difference values when the abnormality occurs, sequentially inputs the prepared sets, constructs a learning model by a convolutional neural network (CNN) in advance, and stores the learning model in advance in a memory (not illustrated) or the like.

When the abnormality detection unit 303 detects the occurrence of the abnormality in the optical fiber cable 100 on the basis of the difference value described above, the pattern of the difference values described above is input to the learning model. As a result, the abnormality detection unit 303 acquires information on the type of abnormality as an output result of the learning model.

### Hardware Configuration of Detection Apparatus According to Each Example Embodiment

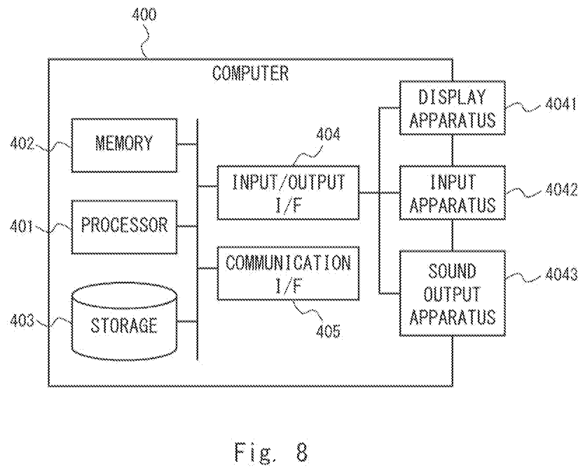

Next, a hardware configuration of a computer 400 that realizes the detection apparatuses 300A and 300B according to the first and second example embodiments described above will be described with reference to FIG. 8.

As illustrated in FIG. 8, the computer 400 includes a processor 401, a memory 402, a storage 403, an input/output interface (input/output I/F) 404, and a communication interface (communication I/F) 405. The processor 401, the memory 402, the storage 403, the input/output interface 404, and the communication interface 405 are connected by a data transmission line for mutually transmitting or receiving data.

The processor 401 is an arithmetic processing apparatus such as a central processing unit (CPU) or a graphics processing unit (GPU). The memory 402 is a memory such as a random access memory (RAM) or a read only memory (ROM). The storage 403 is a storage device such as a hard disk drive (HDD), a solid state drive (SSD), or a memory card. Furthermore, the storage 403 may be a memory such as a RAM or a ROM.

A program is stored in the storage 403. This program includes a group of commands (or software code) for causing the computer 400 to perform one or more functions of the detection apparatuses 300A and 300B described above when being read by the computer. The acquisition units 31 and 301, the environment detection unit 302, and the abnormality detection units 30 and 303 in the detection apparatuses 300A and 300B described above may be realized by the processor 401 reading and executing a program stored in the storage 403. Furthermore, the storage function in the detection apparatuses 300A and 300B described above may be realized by the memory 402 or the storage 403.

Furthermore, the program may be stored in a non-transitory computer readable medium or a tangible storage medium. As an example and not by way of limitation, the computer readable medium or the tangible storage medium includes a RAM, a ROM, a flash memory, an SSD or other memory technology, a compact disc (CD)-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer readable medium or a communication medium. As an example and not by way of limitation, the transitory computer readable medium or the communication medium includes an electrical signal, an optical signal, an acoustic signal, or other forms of propagation signals.

The input/output interface 404 is connected to a display apparatus 4041, an input apparatus 4042, a sound output apparatus 4043, and the like. The display apparatus 4041 is an apparatus that displays a screen corresponding to drawing data processed by the processor 401, such as a liquid crystal display (LCD), a cathode ray tube (CRT) display, or a monitor. The input apparatus 4042 is an apparatus that receives an input of an operation of the operator, and is, for example, a keyboard, a mouse, a touch sensor, or the like. The display apparatus 4041 and the input apparatus 4042 may be integrated, and may be realized as a touch panel. The sound output apparatus 4043 is an apparatus that acoustically outputs sound corresponding to acoustic data that has been processed by the processor 401, such as a speaker.

The communication interface 405 transmits or receives data to and from an external apparatus. For example, the communication interface 405 performs communication with the external apparatus via a wired communication line or a wireless communication line.

Although the present disclosure has been described with reference to the example embodiments, the present disclosure is not limited to the example embodiments described above. Various modifications that can be understood by those skilled in the art can be made to the configuration and details of the present disclosure within the scope of the present disclosure.

For example, in the above-described example embodiments, an example has been described in which the traveling state of the vehicle is detected as the environment around the optical fiber cable, but the present disclosure is not limited thereto. For example, the present disclosure is also applicable to a detection system that detects an intruder or detects a state of a structure such as a utility pole as an environment around an optical fiber cable.

In addition, part or all of the above-described example embodiments may be described in the Supplementary notes below, but are not limited thereto.

### Supplementary Note 1

A detection system comprising:

a first optical fiber cable and a second optical fiber cable;

a sensing unit configured to acquire first sensing data corresponding to the first optical fiber cable and second sensing data corresponding to the second optical fiber cable by performing optical fiber sensing using each of the first optical fiber cable and the second optical fiber cable; and

an abnormality detection unit configured to detect occurrence of abnormality in the first optical fiber cable or the second optical fiber cable on the basis of both the first sensing data and the second sensing data.

### Supplementary Note 2

The detection system according to Supplementary note 1,

wherein each of the first sensing data and the second sensing data includes vibration data, and

wherein the abnormality detection unit is configured to detect the occurrence of the abnormality on the basis of a difference value between vibration intensity indicated by the first sensing data and vibration intensity indicated by the second sensing data.

### Supplementary Note 3

The detection system according to Supplementary note 2,

wherein when detecting the occurrence of the abnormality on the basis of the difference value, the abnormality detection unit is configured to specify the first optical fiber cable or the second optical fiber cable corresponding to the sensing data in which the change occurs, among the first sensing data and the second sensing data, as the optical fiber cable in which the abnormality occurs.

### Supplementary Note 4

The detection system according to Supplementary note 2 or 3,

wherein the abnormality detection unit is configured to monitor the difference value in response to a change in either the first sensing data or the second sensing data.

### Supplementary Note 5

The detection system according to any one of Supplementary notes 1 to 4,

wherein the abnormality includes damage due to animal feeding damage.

### Supplementary Note 6

The detection system according to any one of Supplementary notes 1 to 5,

wherein the sensing unit is configured to acquire the first sensing data and the second sensing data by performing distributed optical fiber sensing using each of the first optical fiber cable and the second optical fiber cable.

### Supplementary Note 7

The detection system according to any one of Supplementary notes 1 to 6, further comprising:

an environment detection unit configured to detect an environment around the first optical fiber cable and the second optical fiber cable on the basis of at least one of the first sensing data and the second sensing data.

### Supplementary Note 8

A detection apparatus comprising:

an acquisition unit configured to acquire first sensing data corresponding to a first optical fiber cable and second sensing data corresponding to a second optical fiber cable from a sensing unit configured to perform optical fiber sensing using each of the first optical fiber cable and the second optical fiber cable; and

an abnormality detection unit configured to detect occurrence of abnormality in the first optical fiber cable or the second optical fiber cable on the basis of both the first sensing data and the second sensing data.

### Supplementary Note 9

The detection apparatus according to Supplementary note 8,

wherein each of the first sensing data and the second sensing data includes vibration data, and

wherein the abnormality detection unit is configured to detect the occurrence of the abnormality on the basis of a difference value between vibration intensity indicated by the first sensing data and vibration intensity indicated by the second sensing data.

### Supplementary Note 10

The detection apparatus according to Supplementary note 9,

wherein when detecting the occurrence of the abnormality on the basis of the difference value, the abnormality detection unit is configured to specify the first optical fiber cable or the second optical fiber cable corresponding to the sensing data in which the change occurs, among the first sensing data and the second sensing data, as the optical fiber cable in which the abnormality occurs.

### Supplementary Note 11

The detection apparatus according to Supplementary note 9 or 10,

wherein the abnormality detection unit is configured to monitor the difference value in response to a change in either the first sensing data or the second sensing data.

### Supplementary Note 12

The detection apparatus according to any one of Supplementary notes 8 to 11,

wherein the abnormality includes damage due to animal feeding damage.

### Supplementary Note 13

The detection apparatus according to any one of Supplementary notes 8 to 12,

wherein the sensing unit is configured to perform distributed optical fiber sensing using each of the first optical fiber cable and the second optical fiber cable.

### Supplementary Note 14

The detection apparatus according to any one of Supplementary notes 8 to 13, further comprising:

an environment detection unit configured to detect an environment around the first optical fiber cable and the second optical fiber cable on the basis of at least one of the first sensing data and the second sensing data.

### Supplementary Note 15

A detection method by a detection apparatus, comprising:

an acquisition step of acquiring first sensing data corresponding to a first optical fiber cable and second sensing data corresponding to a second optical fiber cable from a sensing unit configured to perform optical fiber sensing using each of the first optical fiber cable and the second optical fiber cable; and

an abnormality detection step of detecting occurrence of abnormality in the first optical fiber cable or the second optical fiber cable on the basis of both the first sensing data and the second sensing data.

### Supplementary Note 16

The detection method according to Supplementary note 15,

wherein each of the first sensing data and the second sensing data includes vibration data, and

wherein in the abnormality detection step, the occurrence of the abnormality is detected on the basis of a difference value between vibration intensity indicated by the first sensing data and vibration intensity indicated by the second sensing data.

### Supplementary Note 17

The detection method according to Supplementary note 16,

wherein in the abnormality detection step, when the occurrence of the abnormality is detected on the basis of the difference value, the first optical fiber cable or the second optical fiber cable corresponding to the sensing data in which the change occurs, among the first sensing data and the second sensing data, is specified as the optical fiber cable in which the abnormality occurs.

### Supplementary Note 18

The detection method according to Supplementary note 16 or 17,

wherein in the abnormality detection step, the difference value is monitored in response to a change in either the first sensing data or the second sensing data as a trigger.

### Supplementary Note 19

The detection method according to any one of Supplementary notes 15 to 18,

wherein the abnormality includes damage due to animal feeding damage.

### Supplementary Note 20

The detection method according to any one of Supplementary notes 15 to 19,

wherein the sensing unit is configured to perform distributed optical fiber sensing using each of the first optical fiber cable and the second optical fiber cable.

### Supplementary Note 21

The detection method according to any one of Supplementary notes 15 to 20, further comprising:

an environment detection step of detecting an environment around the first optical fiber cable and the second optical fiber cable on the basis of at least one of the first sensing data and the second sensing data.

### Reference Signs List

1, 1A, 1B DETECTION SYSTEM
10-1, 100-1 FIRST OPTICAL FIBER CABLE
10-2, 100-2 SECOND OPTICAL FIBER CABLE
11-1, 101-1 FIRST OPTICAL FIBER
11-2, 101-2 SECOND OPTICAL FIBER
20 SENSING UNIT
30, 303 ABNORMALITY DETECTION UNIT
31, 301 ACQUISITION UNIT
200 SENSING APPARATUS
201 FIRST DFOS UNIT
202 SECOND DFOS UNIT
300A, 300B DETECTION APPARATUS
302 ENVIRONMENT DETECTION UNIT
400 COMPUTER
401 PROCESSOR
402 MEMORY
403 STORAGE
404 INPUT/OUTPUT INTERFACE
4041 DISPLAY APPARATUS
4042 INPUT APPARATUS
4043 SOUND OUTPUT APPARATUS
405 COMMUNICATION INTERFACE

What is claimed is:

1. A detection system comprising:
a first optical fiber cable and a second optical fiber cable;
at least one memory storing instructions, and
at least one processor configured to execute the instructions to;
acquire first sensing data corresponding to the first optical fiber cable and second sensing data corresponding to the second optical fiber cable by performing optical fiber sensing using each of the first optical fiber cable and the second optical fiber cable; and
detect occurrence of abnormality in the first optical fiber cable or the second optical fiber cable on the basis of both the first sensing data and the second sensing data.

2. The detection system according to claim 1,
wherein each of the first sensing data and the second sensing data includes vibration data, and
wherein the at least one processor is further configured to execute the instructions to detect the occurrence of the abnormality on the basis of a difference value between vibration intensity indicated by the first sensing data and vibration intensity indicated by the second sensing data.

3. The detection system according to claim 2,
wherein when detecting the occurrence of the abnormality on the basis of the difference value, the at least one processor is further configured to execute the instructions to specify the first optical fiber cable or the second optical fiber cable corresponding to the sensing data in which the change occurs, among the first sensing data and the second sensing data, as the optical fiber cable in which the abnormality occurs.

4. The detection system according to claim 2,
wherein the at least one processor is further configured to execute the instructions to monitor the difference value in response to a change in either the first sensing data or the second sensing data.

5. The detection system according to claim 1,
wherein the abnormality includes damage due to animal feeding damage.

6. The detection system according to claim 1,
wherein the at least one processor is further configured to execute the instructions to acquire the first sensing data and the second sensing data by performing distributed optical fiber sensing using each of the first optical fiber cable and the second optical fiber cable.

7. The detection system according to claim 1,
wherein the at least one processor is further configured to execute the instructions to detect an environment around the first optical fiber cable and the second optical fiber cable on the basis of at least one of the first sensing data and the second sensing data.

8. A detection apparatus comprising:
at least one memory storing instructions, and
at least one processor configured to execute the instructions to;
acquire first sensing data corresponding to a first optical fiber cable and second sensing data corresponding to a second optical fiber cable from a sensing unit configured to perform optical fiber sensing using each of the first optical fiber cable and the second optical fiber cable; and
detect occurrence of abnormality in the first optical fiber cable or the second optical fiber cable on the basis of both the first sensing data and the second sensing data.

9. The detection apparatus according to claim 8,
wherein each of the first sensing data and the second sensing data includes vibration data, and
wherein the at least one processor is further configured to execute the instructions to detect the occurrence of the abnormality on the basis of a difference value between vibration intensity indicated by the first sensing data and vibration intensity indicated by the second sensing data.

10. The detection apparatus according to claim 9,
wherein when detecting the occurrence of the abnormality on the basis of the difference value, the at least one processor is further configured to execute the instructions to specify the first optical fiber cable or the second optical fiber cable corresponding to the sensing data in which the change occurs, among the first sensing data and the second sensing data, as the optical fiber cable in which the abnormality occurs.

11. The detection apparatus according to claim 9,
wherein the at least one processor is further configured to execute the instructions to monitor the difference value in response to a change in either the first sensing data or the second sensing data.

12. The detection apparatus according to claim 8,
wherein the abnormality includes damage due to animal feeding damage.

13. The detection apparatus according to claim 8,
wherein the sensing unit is configured to perform distributed optical fiber sensing using each of the first optical fiber cable and the second optical fiber cable.

14. The detection apparatus according to claim 8,
wherein the at least one processor is further configured to execute the instructions to detect an environment around the first optical fiber cable and the second optical fiber cable on the basis of at least one of the first sensing data and the second sensing data.

15. A detection method by a detection apparatus, comprising:
an acquisition step of acquiring first sensing data corresponding to a first optical fiber cable and second sensing data corresponding to a second optical fiber cable from a sensing unit configured to perform optical fiber sensing using each of the first optical fiber cable and the second optical fiber cable; and
an abnormality detection step of detecting occurrence of abnormality in the first optical fiber cable or the second optical fiber cable on the basis of both the first sensing data and the second sensing data.

16. The detection method according to claim 15,
wherein each of the first sensing data and the second sensing data includes vibration data, and
wherein in the abnormality detection step, the occurrence of the abnormality is detected on the basis of a difference value between vibration intensity indicated by the first sensing data and vibration intensity indicated by the second sensing data.

17. The detection method according to claim 16,
wherein in the abnormality detection step, when the occurrence of the abnormality is detected on the basis of the difference value, the first optical fiber cable or the second optical fiber cable corresponding to the sensing data in which the change occurs, among the first sensing data and the second sensing data, is specified as the optical fiber cable in which the abnormality occurs.

18. The detection method according to claim 16,
wherein in the abnormality detection step, the difference value is monitored in response to a change in either the first sensing data or the second sensing data as a trigger.

19. The detection method according to claim 15,
wherein the abnormality includes damage due to animal feeding damage.

20. The detection method according to claim 15,
wherein the sensing unit is configured to perform distributed optical fiber sensing using each of the first optical fiber cable and the second optical fiber cable.

21. (canceled)
